(19) United States
(12) Patent Application Publication
(10) Pub. No.: US 2012/0203955 A1
(43) Pub. Date: Aug. 9, 2012

(54) DATA PROCESSING DEVICE AND SYSTEM INCLUDING THE SAME

(76) Inventors: Jin Hyuk KIM, Hwaseong-si (KR); Jong-Hyun KIM, Suncheon-si (KR); Jang Hwan KIM, Suwon-si (KR)

(21) Appl. No.: 13/366,739

(22) Filed: Feb. 6, 2012

(30) Foreign Application Priority Data
Feb. 7, 2011 (KR) 10-2011-0010480

(51) Int. Cl. G06F 12/00

(52) U.S. Cl. 711/103; 711/154; 711/E12.008

(57) ABSTRACT

A data processing system includes a host and a data processing device configured to store data output from the host. The data processing device includes a compressor configured to compress the data and sort compressed data according to a size of the compressed data and a buffer block configured to store the compressed data that has been sorted.

### CROSS-REFERENCE TO RELATED APPLICATIONS

This application claims priority under 35 U.S.C. §119(a) to Korean Patent Application No. 10-2011-0010480 filed on Feb. 7, 2011, the disclosure of which is incorporated by reference in its entirety herein.

### BACKGROUND

1. Technical Field

Embodiments of the present inventive concept relate to a data processing device, and more particularly, to a data processing device for compressing and storing data and/or decompressing and reading the compressed data and a data processing system including the same.

2. Discussion of Related Art

There has been an increased demand for a solid state drive (SSD) that uses flash memory to retain data. A data processing device, which uses flash memory as a large-capacity storage device for computer systems or portable devices, has a lower memory capacity and a higher cost as compared to a magnetic disk, but has a higher access speed, has a smaller physical size, and has higher impact stability. Further, as technologies for manufacturing flash memories improve, it is expected that the memory capacity of flash memory will increase, the cost of flash memory will decrease, and accordingly flash memory will replace the magnetic disk.

When a data processing device uses flash memory as a large-capacity storage device for a computer system or a portable device, a control device for determining compatibility between a data exchange protocol of a host and the flash memory may be required.

The advanced technology attachment (ATA) standard is an interface standard for connection of storage devices in general computer systems. When flash memory is used as the storage device in the data processing system, the system may include an interface for communicating data according to the ATA standard and an interface for communicating with the flash memory.

### SUMMARY

According to an exemplary embodiment of the present inventive concept, a data processing system includes a host and a data processing device configured to store data output from the host. The data processing device includes a compressor configured to compress the data and sort compressed data according to a size of the compressed data and a buffer block configured to store the compressed data that has been sorted.

The buffer block may include a plurality of buffer groups, each buffer group having ‘m’ unit buffers and each unit buffer sized to have ‘n’ bits, where ‘m’ and ‘n’ are natural numbers. When the size of the compressed data is less than ‘n’ bits, the compressed data may be stored in one of the unit buffers having the size of ‘n’ bits.

The data processing system may further include a flash memory configured to store data output from the buffer block and a flash memory controller configured to control the flash memory. The flash memory may include a page buffer configured to transmit the data output from the buffer block to a memory cell array. The flash memory may be an NAND flash memory. When the ‘m’ unit buffers are all filled with data, data stored in each of the ‘m’ unit buffers may be transmitted to the page buffer. When the size of the compressed data is greater than a size of data that can be stored in the buffer block, the data output from the host may be stored in the page buffer without being compressed.

The data processing system may further include a host interface configured to interface with the host. The host interface may be a serial advanced technology attachment (SATA) interface, a parallel advanced technology attachment (PATA) interface, a universal serial bus (USB) interface, a peripheral component interconnect (PCI) interface, a PCI express interface, or a serial attached small computer interface SCSI (SAS) interface.

The data processing system may further include a central processing unit (CPU) configured to control the flash memory controller, the host interface, and the buffer block.

The data processing device may be a solid state drive (SSD) or a hard disk drive (HDD).

According to an exemplary embodiment of the present inventive concept, a data processing device includes a central processing unit (CPU), a buffer block configured to temporarily store data, and a compressor configured to compress the data and transmit size information of compressed data to the CPU. The CPU may store the compressed data in the buffer block according to the size information.

The buffer block may include a plurality of buffer groups, each buffer group having ‘m’ unit buffers and each unit buffer sized to have ‘n’ bits, where ‘m’ and ‘n’ are natural numbers. When the size of the compressed data is less than ‘n’ bits, the compressed data may be stored in one of the unit buffers having the size of ‘n’ bits.

The data processing device may further include a NAND flash memory configured to store data output from the buffer block and an NAND flash memory controller configured to control the NAND flash memory. The NAND flash memory may include a page buffer configured to transmit the data output from the buffer block to a memory cell array. When the ‘m’ unit buffers are all filled with data, data stored in each of the ‘m’ unit buffers may be transmitted to the page buffer.

The compressor may include a compression sensor configured to determine and transmit the size information of the compressed data to the central processing unit, and the device may further include a decompressor configured to decompress the compressed data.

According to an exemplary embodiment of the inventive concept, a data processing device includes a buffer block, a flash memory, a compressor, a compression sensor, and a CPU. The buffer block includes a first buffer of a first size and a second buffer of a second size greater than the first. The compressor compresses original data input to the device from an external source to generate compressed data. The compression sensor measures a size of the compressed data and outputs the measured size to the CPU. The CPU writes the compressed data into the first buffer when the measured size is the first size or lower, and then writes the compressed data from the first buffer to the flash memory. The CPU writes the compressed data to the second buffer when the measured size is greater than the first size and less than or equal to the second size, and then writes the compressed data from the second buffer to the flash memory. The CPU writes the original data to the flash memory when the measured size is greater than the second size.

The flash memory may include a page buffer and the data written to the flash memory by the CPU may be written to the page buffer. The flash memory may be a NAND flash memory. The second size may be twice the first size. The data processing device may include a decompressor that decompresses the data written to the flash memory.

The data processing system may further include a host interface, a flash memory, and a bus. The host interface may receive the original data from the external source. The flash memory controller may interface the CPU with the flash memory. The bus may connect to the host interface, the CPU, the compressor, the buffer block, and the flash memory. The CPU may control output of the original data from the host interface to the compressor via the bus during a first period. The CPU may control output of the compressed data from the compressor to the buffer block via the bus or output of the original data from the host interface to the flash memory controller during a second period after the first period. The CPU may control output of the compressed data from the buffer block to the flash memory via the bus during a third period after the second period when the compressed data has been output to the buffer block.

### BRIEF DESCRIPTION OF THE DRAWINGS

Embodiments of the present inventive concept will become more apparent by describing in detail exemplary embodiments thereof with reference to the attached drawings in which:

FIG. 1 is a block diagram of a data processing system according to an embodiment of the present inventive concept;

FIG. 2 is a conceptual diagram showing a buffer block illustrated in FIG. 1 in detail according to an exemplary embodiment of the inventive concept;

FIG. 3 is a conceptual diagram showing the buffer block illustrated in FIG. 2 in detail according to an exemplary embodiment of the inventive concept;

FIG. 4 is a detailed block diagram of a compressor/decompressor illustrated in FIG. 1 according to an exemplary embodiment of the inventive concept;

FIG. 5 is a conceptual diagram showing an operation of the compressor/decompressor illustrated in FIG. 1 in detail according to an exemplary embodiment of the inventive concept;

FIG. 6 is a flowchart of a write operation of a data processing device illustrated in FIG. 1 according to an exemplary embodiment of the inventive concept;

FIG. 7 is a flowchart of a read operation of the data processing device illustrated in FIG. 1 according to an exemplary embodiment of the inventive concept;

FIGS. 8A and 8B are graphs showing exemplary compression ratios of the data processing device illustrated in FIG. 1;

FIG. 9 is a diagram of a computer system including the data processing device illustrated in FIG. 1 according to an embodiment of the present inventive concept;

FIG. 10 is a diagram of a computer system including the data processing device illustrated in FIG. 1 according to an exemplary embodiment of the present inventive concept;

FIG. 11 is a diagram of a computer system including the data processing device illustrated in FIG. 1 according to an exemplary embodiment of the present inventive concept; and

FIG. 12 is a diagram of a computer system including the data processing device illustrated in FIG. 1 according to an exemplary embodiment of the present inventive concept.

### DETAILED DESCRIPTION

Exemplary embodiments will be described more fully hereinafter with reference to the accompanying drawings. The exemplary embodiments may, however, be embodied in many different forms and should not be construed as limited to the embodiments set forth herein. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present.

According to at least one exemplary embodiment of the present inventive concept, a data processing device compresses data received from a host and stores compressed data during a write operation. The device may decompress the compressed data and transmit decompressed data to the host during a read operation. Accordingly, the data processing device can increase its capacity of storage space through the compression and decompression of data. Further, when the data processing device uses NAND flash memory in connection the read and write operations, write times and/or read times of the device can be reduced. However, embodiments of the data processing device are not limited to any particular type of flash memory.

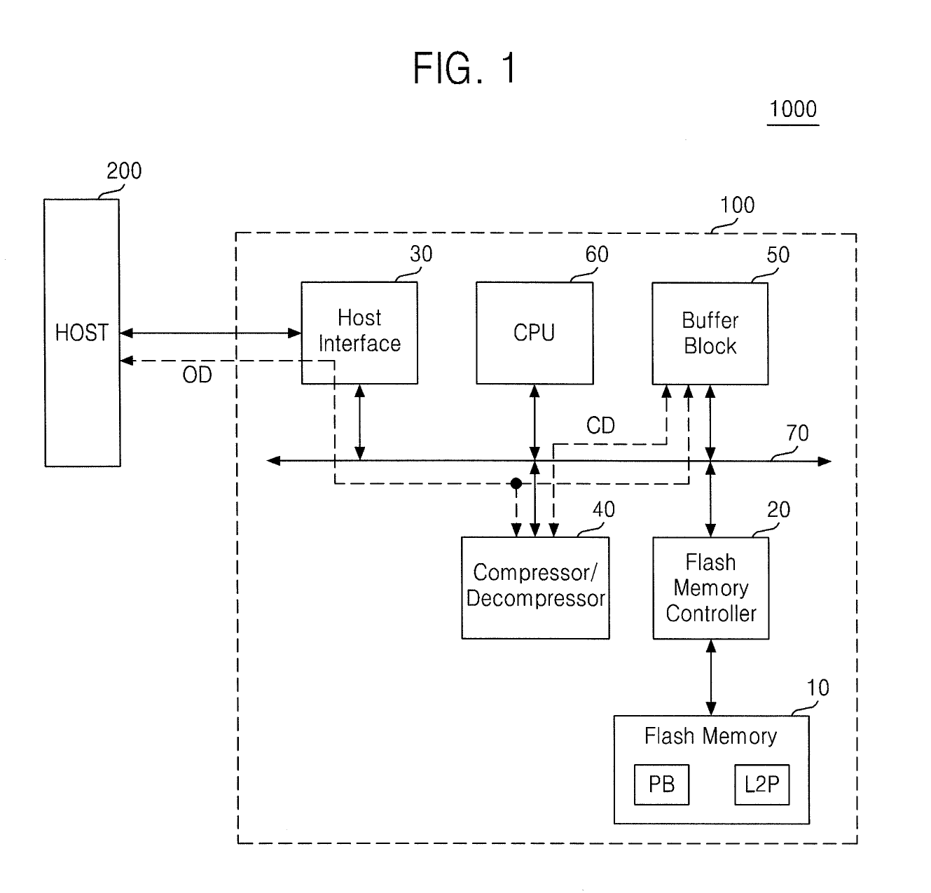

The data processing device may take the size of a page buffer into account when compressing and storing data received from the host. In the below discussions, it is assumed that the size of the page buffer of the NAND flash memory is 8 Kbytes and the data received from the host is 8 Kbytes in size. However, embodiments of the inventive concept are not limited thereto, as the size of the page buffer and the data received from the host may vary considerably. The received data may be sorted (or classified) according to a compressed size when stored. The technical features of the inventive concept will be described in further detail below with reference to FIG. 1.

FIG. 1 is a block diagram of a data processing system 1000 according to an exemplary embodiment of the present inventive concept. Referring to FIG. 1, the data processing system 1000 includes a data processing device 100 and a host 200. The data processing device 100 includes a flash memory 10, a flash memory controller 20, a host interface 30, a compressor/decompressor 40, a buffer block 50, a central processing unit (CPU) 60, and a bus 70.

The flash memory 10 is a non-volatile memory and stores original data OD transmitted from the host 200. The flash memory 10 may be implemented by an NAND flash memory. The flash memory 10 may be implemented as a single chip or a plurality of chips to expand the memory capacity of the flash memory 10. The flash memory controller 20 controls the flash memory 10.

The host interface 30 interfaces the flash memory 10 and the host 20. For example, the host interface 30 may be a serial advanced technology attachment (SATA) interface, a parallel advanced technology attachment (PATA) interface, a universal serial bus (USB) interface, a peripheral component interconnect (PCI) interface, a PCI express interface, or a serial attached SCSI (SAS) interface.

The compressor/decompressor 40 compresses original data OD transmitted from the host 200 and decompresses compressed data CD stored in the flash memory 10.

The compressor/decompressor 40 may be implemented in hardware. However, in an alternate embodiment, the function of the compressor/decompressor 40 is emulated in software by the CPU 60. The performance of the data processing device may be higher when the compressor/decompressor 40 is implemented in hardware as compared to when its function is emulated by the CPU 60. In an alternate embodiment one of the functions of the compressor/decompressor 40 is implemented in hardware (e.g., compression or decompression) and the other is emulated in software.

The buffer block 50 stores the compressed data CD received from the compressor/decompressor 40. The compressed data CD is sorted according to its size and stored in the buffer block 50. The buffer block 50 transmits the compressed data CD to the flash memory 10 in response to a control signal from the CPU 60. The buffer block 50 may also store the original data OD to be transmitted to the host 200. For example, the buffer block 50 may be implemented by static random access memory (SRAM) or dynamic random access memory (DRAM).

The buffer block 50 includes a plurality of buffers having different sizes. For example, in at least one embodiment, the buffer block 50 includes a 1-Kbyte buffer group, a 2-Kbyte buffer group, a 4-Kbyte buffer group, and an 8-Kbyte buffer group. The 1-Kbyte buffer group includes eight 1-Kbyte unit buffers. The 2-Kbyte buffer group includes four 2-Kbyte unit buffers. The 4-Kbyte buffer group includes two 4-Kbyte unit buffers. The 8-Kbyte buffer group includes one 8-Kbyte unit buffer. However, embodiments of the buffer block 50 are not limited thereto. For example, the buffer block 50 may include a lesser number of buffer groups (e.g., a 1K, 2K, and a 4K), a greater number of buffer groups (e.g., 0.5K, 1K, 2K, 4K, and 8K), the size of the buffer groups may differ from 1K, 2K, 4K, and 8K (e.g., 1.5K, 3K, 6K), the size of each subsequently larger buffer group need not be twice the prior buffer group (e.g., 1K, 1.5K, 2K, 2.5K, etc.), and the number of units of each buffer group need not be half the prior buffer group (e.g., 2 1K unit buffers, 4 2K unit buffers, 2 4K unit buffers, 4 8K unit buffers, etc).

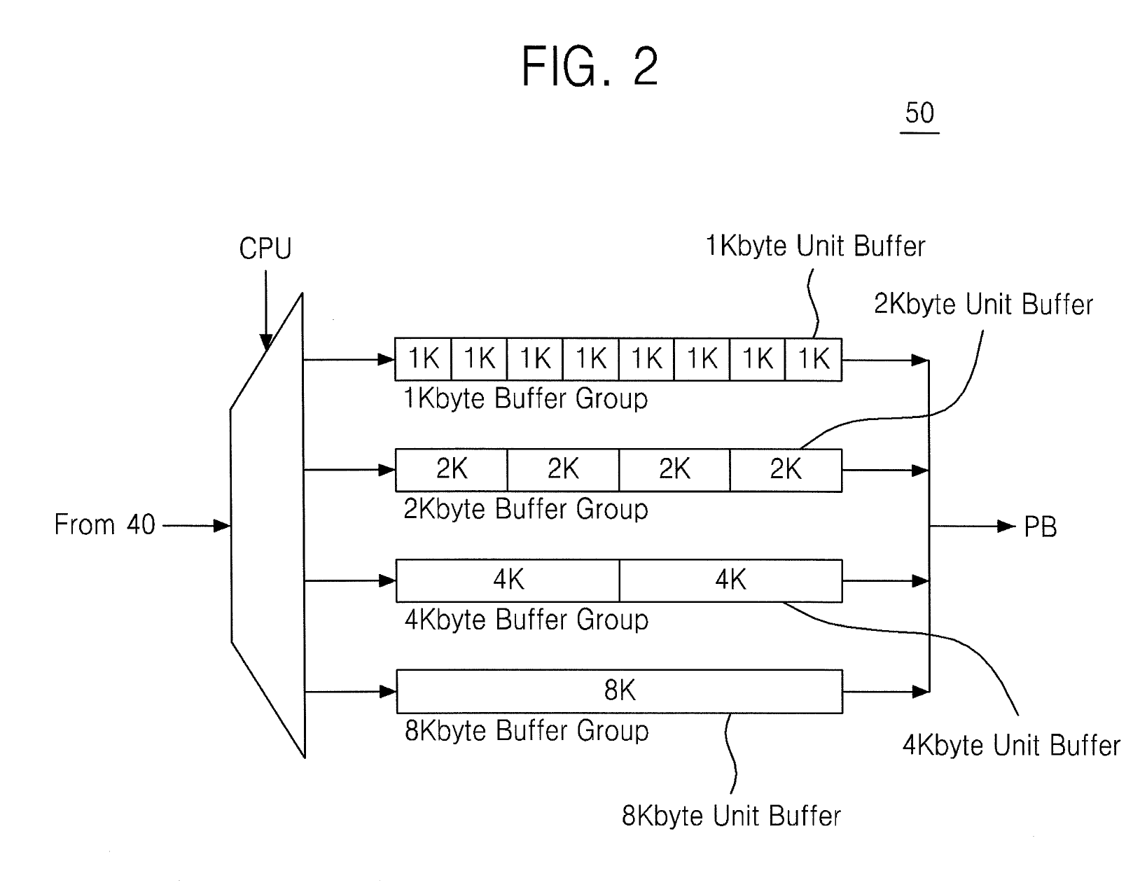

In at least one exemplary embodiment, the sum of the capacities of the eight 1-Kbyte unit buffers, the sum of the capacities of the four 2-Kbyte unit buffers, the sum of the capacities of the two 4-Kbyte unit buffers, and the capacity of the one 8-Kbyte unit buffer are designed to be the same as one another. The structure of the buffer block 50 will be described in more detail below with reference to FIG. 2.

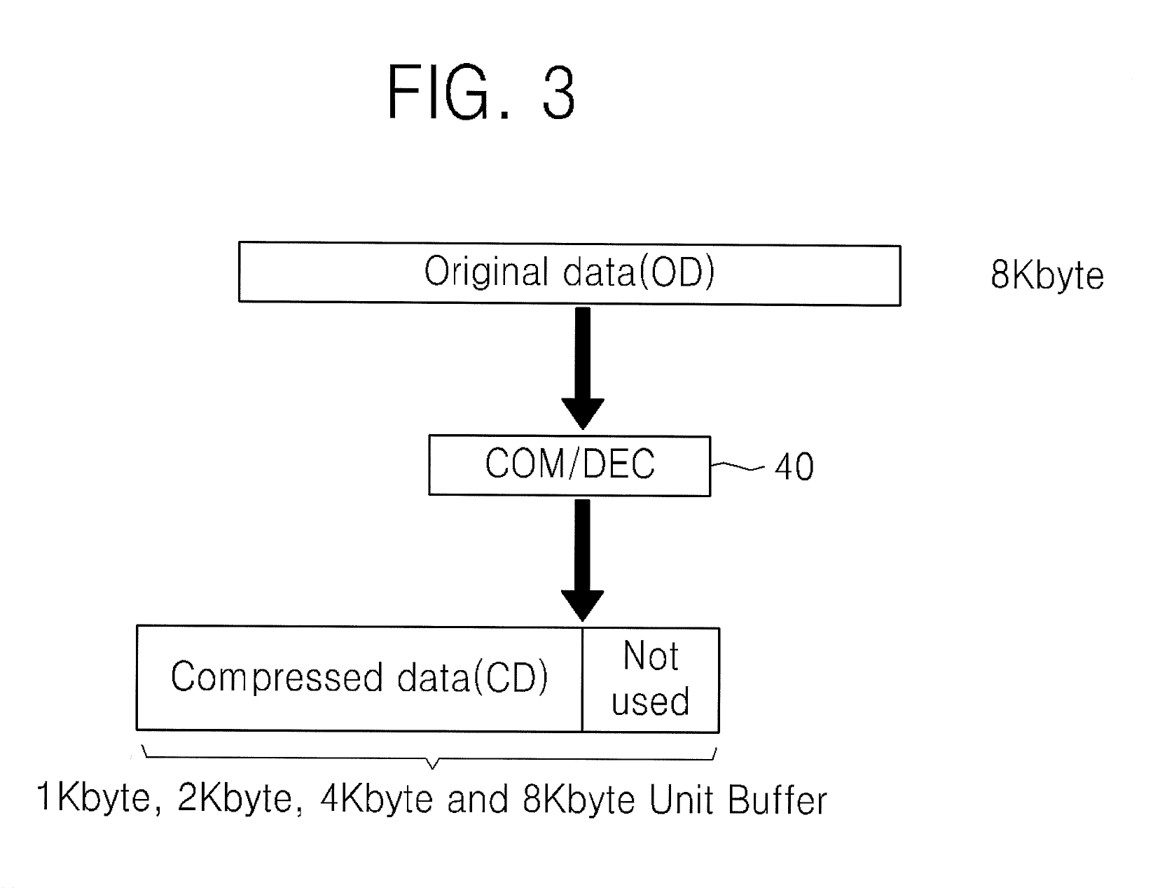

When the size of the compressed data CD is less than 1 Kbyte, the compressed data CD is stored in a 1-Kbyte unit buffer. When the size of the compressed data CD is greater than 1 Kbyte and 2 Kbytes or less, the compressed data CD is stored in a 2-Kbyte unit buffer. When the size of the compressed data CD is greater than 2 Kbytes and 4 Kbytes or less, the compressed data CD is stored in a 4-Kbyte unit buffer. When the size of the compressed data CD is greater than 4 Kbytes and 8 Kbytes or less, the compressed data CD is stored in an 8-Kbyte unit buffer. When the size of the compressed data CD is greater than 8 Kbytes, the original data OD is stored in the 8-Kbyte unit buffer. The operation of the buffer block 50 will be described in more detail below with reference to FIG. 3.

Information L2P about sorting the compressed data CD (hereinafter, referred to as “compressed data sorting information L2P”) may be stored in a logical-to-physical transition table. The logical-to-physical transition table is used to convert a logical address into a physical address. In addition, the compressed data sorting information L2P may be stored in the flash memory 10 or the buffer block 50 in a table form.

In at least one embodiment, the CPU 60 stores the compressed data sorting information L2P in the flash memory 10. For example, the compressed data sorting information L2P is stored in a spare area, a particular block or a particular page in the flash memory 10.

The CPU 60 also controls the flash memory controller 20, the host interface 30, and the buffer block 50. For example, the CPU 60 may be implemented by an ARM™ processor. The bus 70 connects the flash memory controller 20, the host interface 30, the compressor/decompressor 40, the buffer block 50, and the CPU 60 to one another.

For example, the data processing device 100 may be implemented as a solid state drive (SSD) or a hard disk drive (HDD).

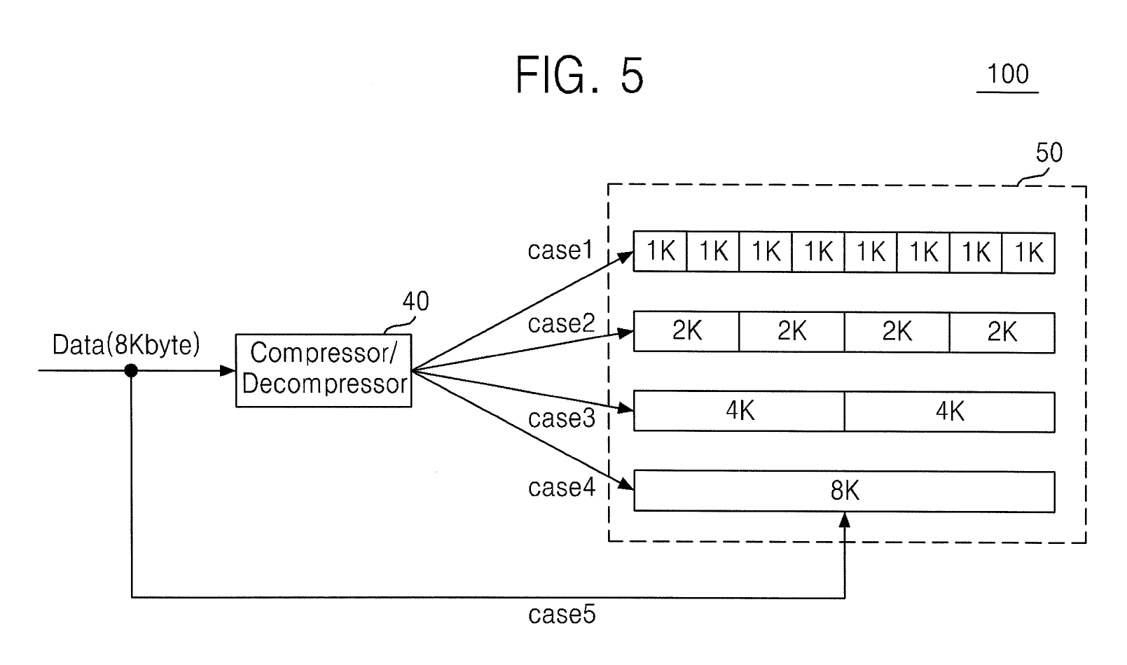

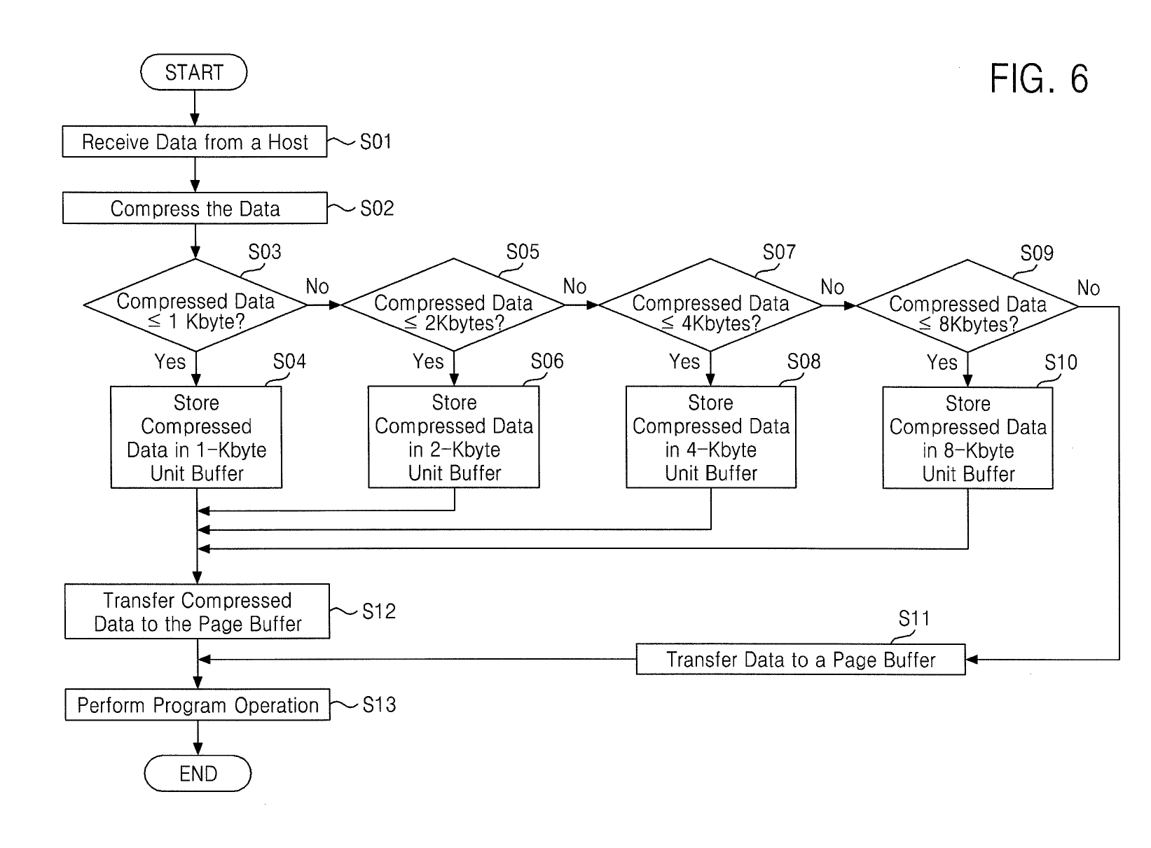

A writing method and reading method of the data processing device 100 will be described in more detail with below reference to FIGS. 5 and 6.

FIG. 2 is a conceptual diagram showing the buffer block 50 illustrated in FIG. 1 in detail according to an exemplary embodiment of the inventive concept. Referring to FIGS. 1 and 2, the flash memory 10 includes a page buffer PB, which is used to read the original data OD from a memory cell array or write the original data OD or the compressed data CD to the memory cell array. It is assumed that the size of the page buffer PB is 8 Kbytes.

The compressed data CD transmitted from the compressor/decompressor 40 is stored in one of a plurality of buffer groups included in the buffer block 50 in response to a control signal from the CPU 60. The buffer block 50 may include a multiplexer that receives the control signal, which causes input compressed data CD to be output to either one of the 1 Kbyte buffer groups, one of the 2 Kbyte buffer groups, one of the 3 Kbyte buffer groups, or the 8 Kbyte buffer group.

For example, the buffer block 50 may include a 1-Kbyte buffer group, a 2-Kbyte buffer group, a 4-Kbyte buffer group, and an 8-Kbyte buffer group. The 1-Kbyte buffer group includes eight 1-Kbyte unit buffers. The 2-Kbyte buffer group includes four 2-Kbyte unit buffers. The 4-Kbyte buffer group includes two 4-Kbyte unit buffers. The 8-Kbyte buffer group includes one 8-Kbyte unit buffer. As discussed above, the number of buffer groups and the numbers of unit buffers are not limited to this example.

The sum of the capacities of the eight 1-Kbyte unit buffers, the sum of the capacities of the four 2-Kbyte unit buffers, the sum of the capacities of the two 4-Kbyte unit buffers, and the capacity of the one 8-Kbyte unit buffer are all constant at 8 Kbytes.

Alternatively, the buffer block 50 may include a plurality of buffer groups where each buffer group include ‘m’ unit buffers of size ‘n’ each where ‘m’ and ‘n’ are natural numbers. For example, when ‘in’ is 4 and ‘n’ is 3, each buffer group includes 4 3-bit unit buffers. When all of the ‘m’ unit buffers are filled with data, data stored in each of the ‘m’ unit buffers is transmitted to the page buffer PB.

FIG. 3 is a conceptual diagram showing the buffer block illustrated in FIG. 2 in detail according to an exemplary embodiment of the inventive concept. Referring to FIGS. 1 through 3, when the original data OD transmitted from the host 200 is 8 Kbytes in size, the compressor/decompressor 40 compresses the 8-Kbyte original data OD and generates the compressed data CD. The CPU 60 sorts the compressed data CD according to the size and stores the compressed data CD in the buffer block 50. The compressed data CD generated by the compressor/decompressor 40 should be less than 8 Kbytes in size.

When the compressed data CD is 1 Kbyte or less, the compressed data CD is stored in a 1-Kbyte unit buffer. In at least one embodiment, a storage region or space remaining in the 1-Kbyte unit buffer after the compressed data CD is stored therein is not used (e.g., empty). When the compressed data CD is greater than 1 Kbyte and 2 Kbytes or less, the compressed data CD is stored in a 2-Kbyte unit buffer. In at least one embodiment a storage region or space remaining in the 2-Kbyte unit buffer after the compressed data CD is stored therein is not used (e.g., empty). Similarly, when the compressed data CD is greater than 2 Kbyte and 4 Kbytes or less, the compressed data CD is stored in a 4-Kbyte unit buffer. In at least one embodiment, a storage region or space remaining in the 4-Kbyte unit buffer after the compressed data CD is stored therein is not used (e.g., empty). When the compressed data CD is greater than 4 Kbyte and 8 Kbytes or less, the compressed data CD is stored in the 8-Kbyte unit buffer. In at least one embodiment, a storage region or space remaining in the 8-Kbyte unit buffer after the compressed data CD is stored therein is not used (e.g., empty). The compressed data sorting information L2P may be stored in the storage region or the space remaining after the compressed data CD is stored in a unit buffer.

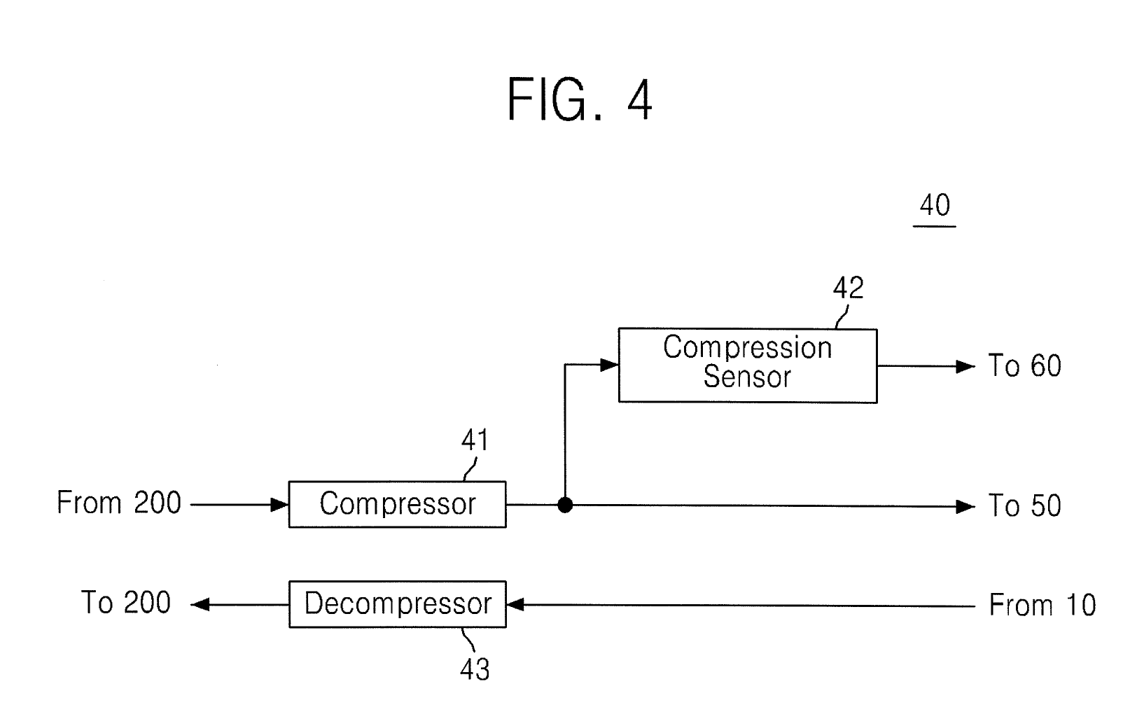

FIG. 4 is a detailed block diagram of the compressor/decompressor 40 illustrated in FIG. 1 according to an exemplary embodiment of the inventive concept. Referring to FIGS. 1 and 4, the compressor/decompressor 40 includes a compressor 41, a compression sensor 42, and a decompressor 43.

The compressor 41 compresses the original data OD transmitted from the host 200 to generate the compressed data CD. The compressor 41 transmits the compressed data CD to the buffer block 50. The compression sensor 42 transmits size information of the compressed data CD to the CPU 60. For example, the compression sensor 42 can send a signal to the CPU 60 that indicates the size of the compressed data CD. The CPU 60 can send a signal to the buffer block 50 to route compressed data CD to the appropriately sized buffer group of the buffer block 50. The decompressor 43 decompresses the compressed data CD transmitted from the flash memory 10 with reference to the compressed data sorting information L2P and transmits decompressed data (e.g., original data OD) to the host 200 through the host interface 30.

FIG. 5 is a conceptual diagram showing an operation of the compressor/decompressor 40 illustrated in FIG. 1 in detail according to an exemplary embodiment of the inventive concept. Referring to FIGS. 1 through 5, it is assumed that the size of the original data OD transmitted from the host 200 is 8 Kbytes. The compressor/decompressor 40 compresses the original data OD in response to the control of the CPU 60. The CPU 60 sorts the compressed data CD according to the size of the compressed data CD.

When the compressed data CD is 1 Kbyte or less, the compressed data CD is stored in one of the eight 1-Kbyte unit buffers in case 1. When the compressed data CD is greater than 1 Kbyte and 2 Kbytes or less, the compressed data CD is stored in one of the four 2-Kbyte unit buffers in case 2. When the compressed data CD is greater than 2 Kbytes and 4 Kbytes or less, the compressed data CD is stored in one of the two 4-Kbyte unit buffers in case 3. When the compressed data CD is greater than 4 Kbyte and 8 Kbytes or less, the compressed data CD is stored in the 8-Kbyte unit buffer in case 4. When the compressed data CD is greater than 8 Kbytes, the uncompressed original data OD is stored in the 8-Kbyte unit buffer in case 5.

FIG. 6 is a flowchart of the write operation of the data processing device 100 illustrated in FIG. 1 according to an exemplary embodiment of the inventive concept. Referring to FIGS. 1 through 6, the compressor/decompressor 40 receives the original data OD from the host 200 through the host interface 30 in response to a control signal from the CPU 60 in operation S01. The compressor/decompressor 40 compresses the original data OD and generates the compressed data CD in operation S02. The CPU 60 determines whether the compressed data CD is less than or equal to 1 Kbyte in operation S03. When it is determined that the compressed data CD is less than or equal to 1 Kbyte, the CPU 60 stores the compressed data CD in one of the eight 1-Kbyte unit buffers in operation S04.

When the compressed data CD is greater than 1 Kbyte, the CPU 60 determines whether the compressed data CD is less than or equal to 2 Kbytes in operation S05. When it is determined that the compressed data CD is less than or equal to 2 Kbytes, the CPU 60 stores the compressed data CD in one of the four 2-Kbyte unit buffers in operation S06.

When the compressed data CD is greater than 2 Kbytes, the CPU 60 determines whether the compressed data CD is less than or equal to 4 Kbytes in operation S07. When it is determined that the compressed data CD is less than or equal to 4 Kbytes, the CPU 60 stores the compressed data CD in one of the two 4-Kbyte unit buffers in operation S08.

When the compressed data CD is greater than 4 Kbytes, the CPU 60 determines whether the compressed data CD is less than or equal to 8 Kbytes in operation S09. When it is determined that the compressed data CD is less than or equal to 8 Kbyte, the CPU 60 stores the compressed data CD in the 8-Kbyte unit buffer in operation S10. When the compressed data CD is greater than 8 Kbytes, the CPU 60 transfers the uncompressed original data OD to the page buffer PB in operation S11.

The CPU 60 transfers the compressed data CD to the page buffer PB in operation S12. The flash memory 10 performs a program operation in response to a control signal from the flash memory controller 20 in operation S13.

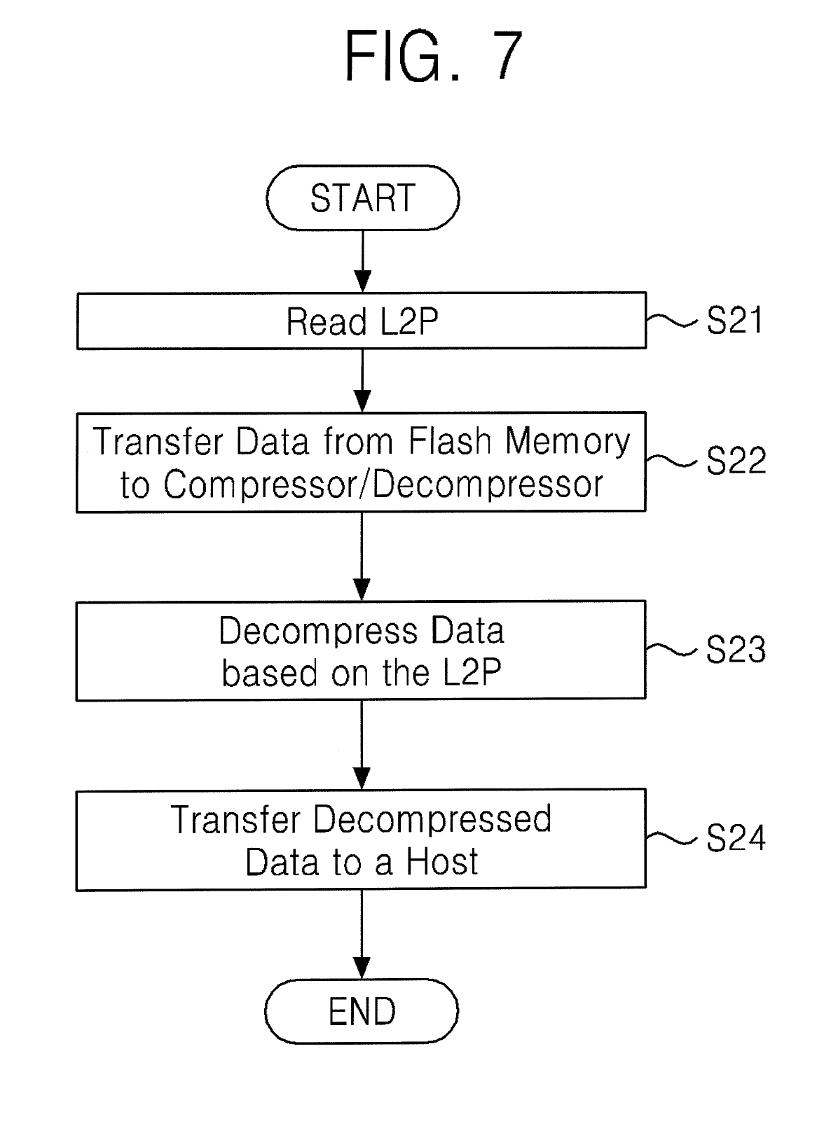

FIG. 7 is a flowchart of the read operation of the data processing device 100 illustrated in FIG. 1 according to an exemplary embodiment of the inventive concept. Referring to FIGS. 1, 2, 3, 4, 5, and 6, the CPU 60 reads the compressed data sorting information L2P from the flash memory 10 in operation S21. The compressor/decompressor 40 receives the compressed data CD from the flash memory 10 in response to a control signal from the CPU 60 in operation S22. The compressor/decompressor 40 decompresses the compressed data CD according to the compressed data sorting information L2P in operation S23. The CPU 60 transfers decompressed data (e.g., original data OD) to the host 200 in operation S24.

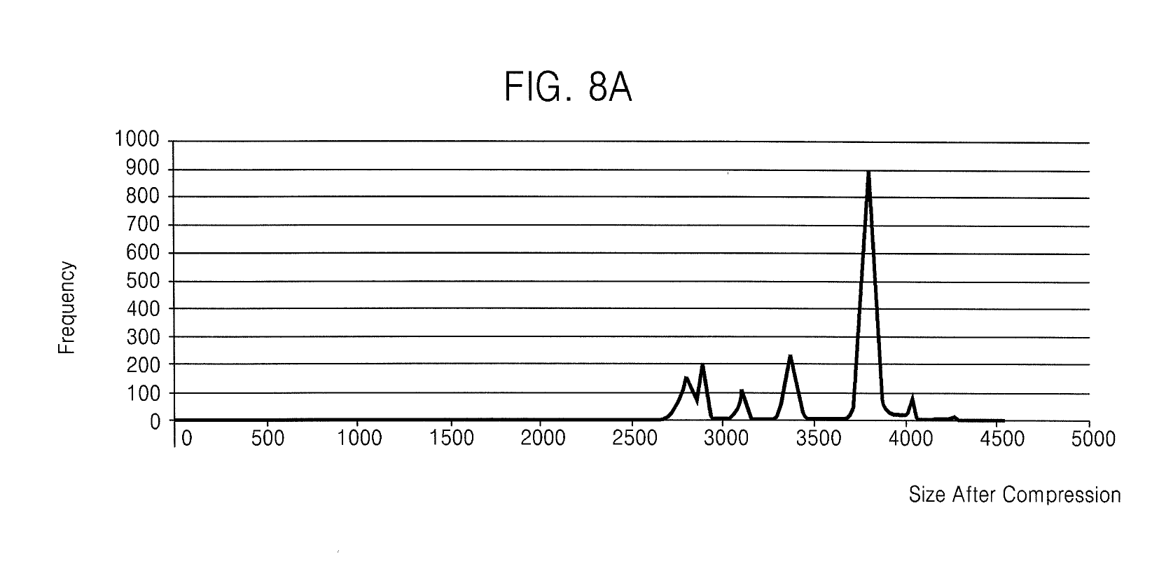

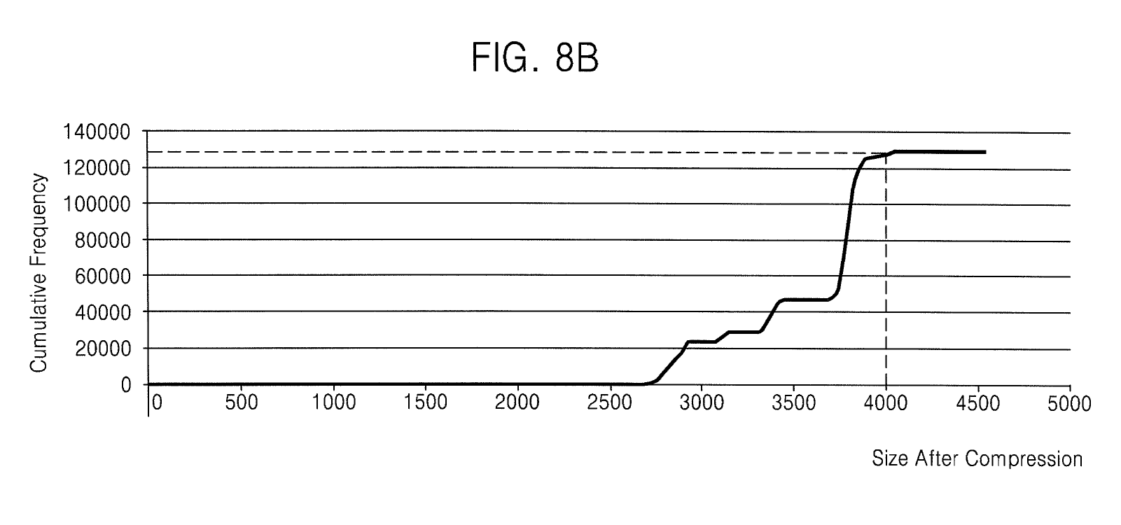

FIGS. 8A and 8B are graphs showing exemplary compression ratios of the data processing device 100 illustrated in FIG. 1. The graphs illustrated in FIGS. 8A and 8B may be obtained using a benchmark program TPC-H or a TPC Benchmark™H (TPC-H). The benchmark program TPC-H may be used to evaluate the performance of a computer.

In FIG. 8A, the X-axis indicates the size of data after compression and the Y-axis indicates a frequency of the size of the compressed data. In FIG. 8B, the X-axis indicates the size of data after compression and the Y-axis indicates a cumulative frequency of the size of the compressed data. FIG. 8A shows the frequency after the original data OD of 8 Kbytes is compressed and converted into the compressed data CD. FIG. 8B shows the cumulative frequency after the original data OD of 8 Kbytes is compressed and converted into the compressed data CD.

Referring to FIGS. 1 through 8B, it is assumed that the total amount of data transmitted from the host 200 is 1014 Mbytes and the original data OD transmitted from the host 200 at one time is 8 Kbytes. However, in alternate embodiments the total amount of data transmitted may be lower or higher than 1014 Mbytes. Referring to FIG. 8A, the frequency of the compressed data CD is highest between 3500 and 4000 bytes in size. Referring to FIG. 8B, the cumulative frequency of the compressed data CD is saturated at about 4000 bytes. In other words, the original data OD from the host 200 is mostly compressed to be less than 4 Kbytes. According to the benchmark program TPC-H, the 1014-Mbyte data transmitted from the host is compressed into 438-Mbyte data. The compression ratio is about 57%.

Accordingly, the compression ratio of the data processing device 100 will be greater than about 50%. For example, when the data processing device 100 has a storage performance of 16 Gbytes, the amount of data that can actually be stored in the data processing device 100 is greater than 32 Gbytes.

In addition, the data processing device 100 can write 16-Kbyte data in a capacity of about 8 Kbytes and can output 16-Kbyte data from 8-Kbyte data, so that the read and write speed of the data processing device 100 is increased.

The data processing device 100 may use a NAND flash memory as a storage medium. The durability of NAND flash memory may decrease as the number of data accesses increases. Since the amount of data read and written is decreased in the data processing device 100, the durability of the NAND flash memory therein is increased.

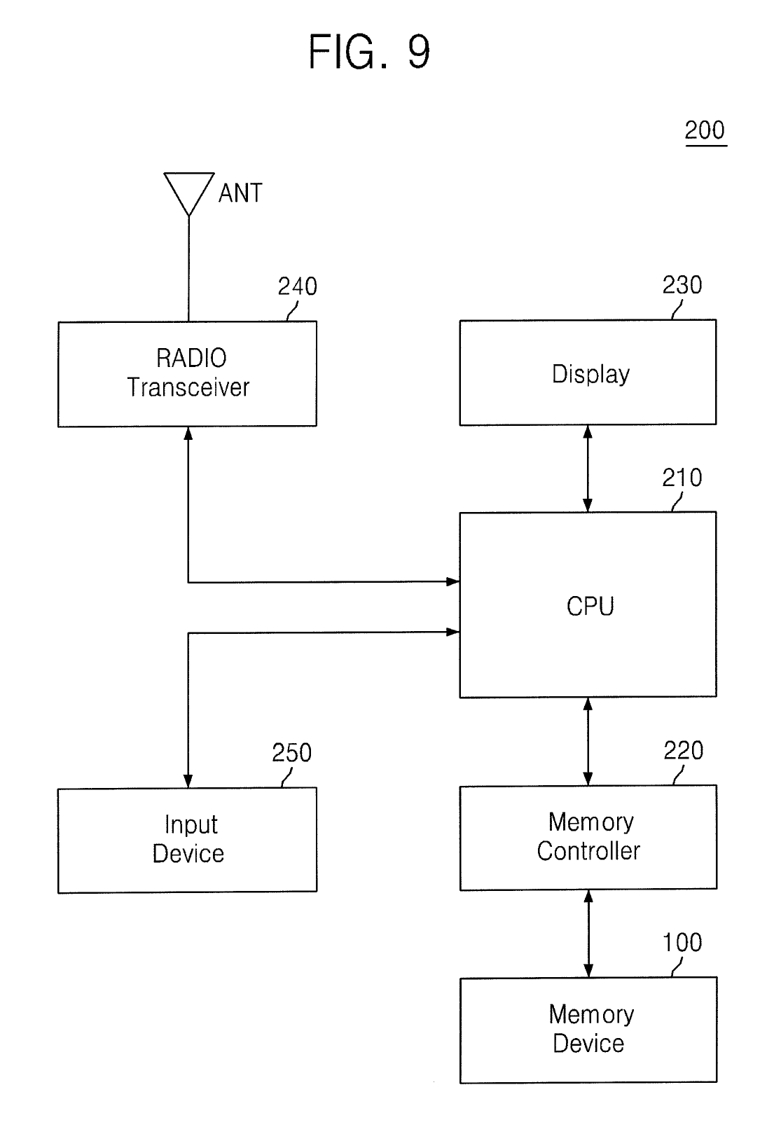

FIG. 9 is a diagram of a computer system 200 including the data processing device 100 illustrated in FIG. 1 according to an exemplary embodiment of the present inventive concept. Referring to FIG. 9, the computer system 200 including the data processing device 100 illustrated in FIG. 1 may be implemented as a cellular phone, a smart phone, a personal digital assistant (PDA), a tablet personal computer, or a radio communication system.

The computer system 200 includes the memory device 100 and a memory controller 220 controlling the operations of the memory device 100.

The memory controller 220 may control the data access operation (e.g., a write operation or a read operation) of the memory device 100 according to a control signal from the CPU 210. Data in the memory device 100 may be displayed through a display 230 according to a control of the CPU 210 and the memory controller 220. A radio transceiver 240 transmits or receives radio signals through an antenna ANT. The radio transceiver 240 may convert radio signals received through the antenna ANT into signals that can be processed by the CPU 210. Accordingly, the CPU 210 may process the signals output from the radio transceiver 240 and transmit the processed signals to the memory controller 220 or the display 230. The memory controller 220 may store the signals processed by the CPU 210 in the memory device 100.

The radio transceiver 240 may also convert signals output from the CPU 210 into radio signals and output the radio signals to an external device through the antenna ANT. An input device 250 enables control signals to be sent to the CPU 210 for controlling the operation of the CPU 210 or data to be processed by the CPU 210 to be input to the computer system 200. The input device 250 may be implemented by a pointing device such as a touch pad or a computer mouse, a keypad, or a keyboard.

The CPU 210 may control the operation of the display 230 to display data output from the memory controller 220, data output from the radio transceiver 240, or data output from the input device 250.

The memory controller 220, which controls the operations of the memory device 100, may be implemented as a part of the CPU 210 or as a separate chip.

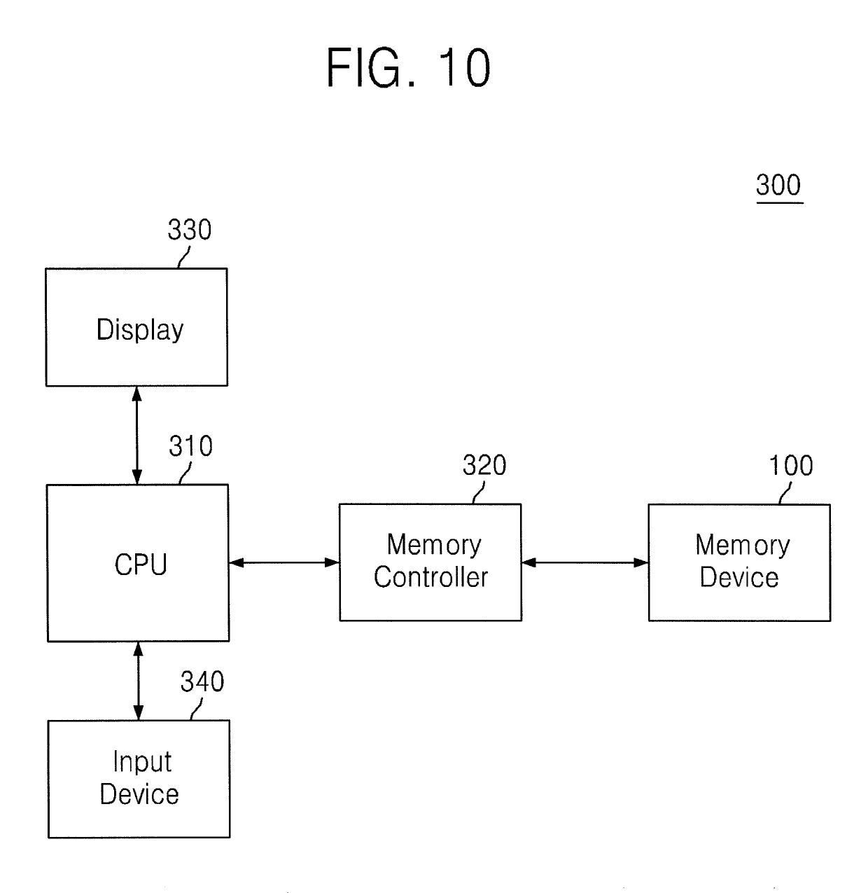

FIG. 10 is a diagram of a computer system 300 including the data processing device 100 illustrated in FIG. 1 according to an exemplary embodiment of the present inventive concept. Referring to FIG. 10, the computer system 300 including the data processing device 100 illustrated in FIG. 1 may be implemented as a personal computer (PC), a network server, a tablet PC, a netbook, a smart pad, an e-reader, a PDA, a portable multimedia player (PMP), an MP3 player, or an MP4 player. The smart pad may be an IPAD™ or a Galaxy Tab™.

The computer system 300 includes the memory device 100, a memory controller 320 controlling the data processing operations of the memory device 100, a display 330, an input device 340, and a CPU 310.

The CPU 310 may display data stored in the memory device 100 through the display 330 according to data input through the input device 340. The input device 340 may be implemented by a pointing device such as a touch pad or a computer mouse, a keypad, or a keyboard. The CPU 310 may control the overall operation of the computer system 300 and control the operations of the memory controller 320.

The memory controller 320, which may control the operations of the memory device 100, may be implemented as a part of the CPU 310 or as a separate chip.

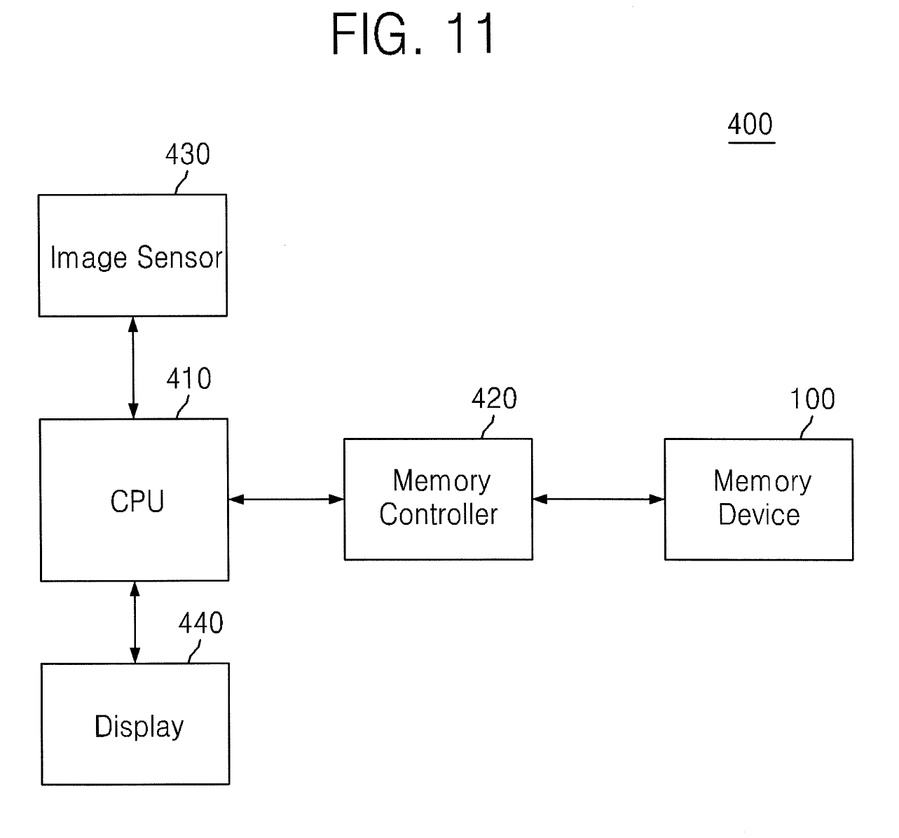

FIG. 11 is a diagram of a computer system 400 including the data processing device 100 illustrated in FIG. 1 according to an exemplary embodiment of the present inventive concept. Referring to FIG. 11, the computer system 400 including the data processing device 100 illustrated in FIG. 1 may be implemented as an image processing device like a digital camera or a cellular phone or smart phone equipped with a digital camera.

The computer system 400 includes the memory device 100 and a memory controller 420 controlling the data processing operation, such as a write operation or a read operation, of the memory device 100. The computer system 400 also includes an image sensor 430, a display 440, and a CPU 410.

The image sensor 430 converts optical images into digital signals and outputs the digital signals to the CPU 410 or the memory controller 420. The digital signals may be displayed through the display 440 or stored in the memory device 100 through the memory controller 420 according to the control of the CPU 410. Data stored in the memory device 100 may be displayed through the display 440 according to the control of the CPU 410 or the memory controller 420. The memory controller 420, which may control the operations of the memory device 100, may be implemented as a part of the CPU 410 or as a separate chip.

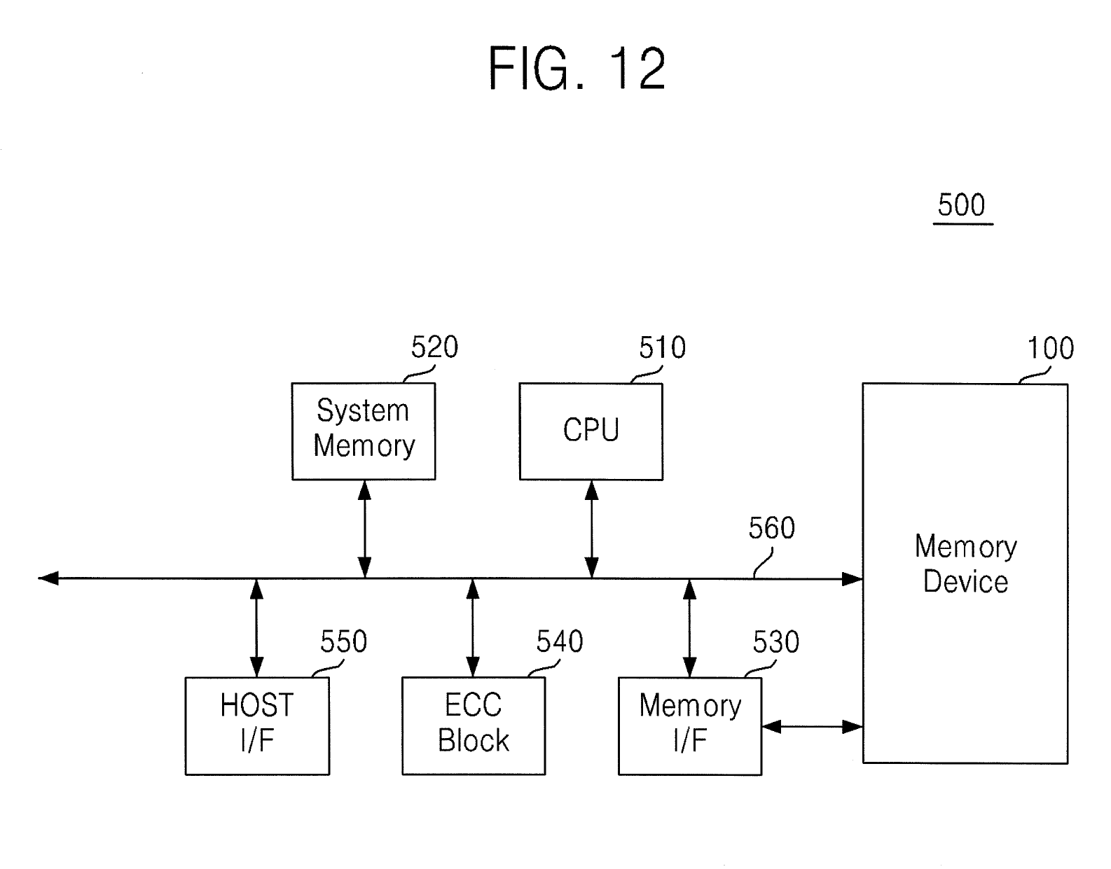

FIG. 12 is a diagram of a computer system 500 including the data processing device 100 illustrated in FIG. 1 according to an exemplary embodiment of the present inventive concept. Referring to FIG. 12, the computer system 500 including the data processing device 100 illustrated in FIG. 1 includes a memory device 100 and a CPU 510 controlling the operation of the memory device 100.

The memory device 100 may be implemented by a non-volatile memory such as a flash memory. The computer system 500 also includes a system memory 520, a memory interface 530, an error correction code (ECC) block 540, and a host interface 550.

The computer system 500 also includes a system memory 520 that may be used as an operation memory of the CPU 510. The system memory 520 may be implemented by a non-volatile memory like read-only memory (ROM) or a volatile memory like SRAM.

A host connected with the computer system 500 may perform data communication with the memory device 100 through the memory interface 530 and the host interface 550.

The ECC block 540 may detect an error bit included in data output from the memory device 100 through the memory interface 530, correct the error bit, and transmit the error-corrected data to the host through the host interface 550 according to the control of the CPU 510. The CPU 510 may control data communication among the memory interface 530, the ECC block 540, the host interface 550, and the system memory 520 through a bus 560.

The computer system 500 may be implemented as a flash memory drive, a USB memory drive, an interchip (IC)-USB memory drive, or a memory stick.

As described above, according to at least one embodiment of the present inventive concept, a data processing device has expanded storage space and increased durability. Further, the data processing device reduces the amount of time taken to write or read data.

While the present inventive concept has been particularly shown and described with reference to exemplary embodiments thereof, it will be understood by those of ordinary skill in the art that various changes in forms and details may be made therein without departing from the spirit and scope of the disclosure.

What is claimed is:

1. A data processing system comprising:
a host; and
a data processing device configured to store data output from the host,
wherein the data processing device comprises:
a compressor configured to compress the data and sort compressed data according to a size of the compressed data; and
a buffer block configured to store the compressed data that has been sorted.

2. The data processing system of claim 1, wherein the buffer block comprises a plurality of buffer groups, each buffer group having ‘m’ unit buffers and each unit buffer sized to have ‘n’ bits, wherein ‘m’ and ‘n’ are natural numbers.

3. The data processing system of claim 2, wherein when the size of the compressed data is less than ‘n’ bits, the compressed data is stored in one of the unit buffers having the size of ‘n’ bits.

4. The data processing system of claim 3, further comprising:
a flash memory configured to store data output from the buffer block; and
a flash memory controller configured to control the flash memory,
wherein the flash memory includes a page buffer configured to transmit the data output from the buffer block to a memory cell array.

5. The data processing system of claim 4, wherein the flash memory is an NAND flash memory.

6. The data processing system of claim 4, wherein when the ‘m’ unit buffers are all filled with data, data stored in each of the ‘m’ unit buffers is transmitted to the page buffer.

7. The data processing system of claim 4, wherein when the size of the compressed data is greater than a size of data that can be stored in the buffer block, the data output from the host is stored in the page buffer without being compressed.

8. The data processing system of claim 4, further comprising a host interface configured to interface with the host, wherein the host interface is one of a serial advanced technology attachment (SATA) interface, a parallel advanced technology attachment (PATA) interface, a universal serial bus (USB) interface, a peripheral component interconnect (PCI) interface, a PCI express interface, and a serial attached SCSI (SAS) interface.

9. The data processing system of claim 1, wherein the data processing device is a solid state drive (SSD).

10. The data processing system of claim 1, wherein the data processing device is a hard disk drive (HDD).

11. A data processing device comprises:
a central processing unit (CPU);
a buffer block configured to temporarily store data; and
a compressor configured to compress the data and transmit size information of compressed data to the CPU,
wherein the CPU stores the compressed data in the buffer block based on the size information.

12. The data processing device of claim 11, wherein the buffer block comprises a plurality of buffer groups each having ‘m’ unit buffers, where each unit buffer is sized to have ‘n’ bits, and when the size of the compressed data is less than ‘n’ bits, the compressed data is stored in one of the unit buffers having the size of ‘n’ bits, wherein ‘m’ and ‘n’ are natural numbers.

13. The data processing device of claim 12, further comprising:
a NAND flash memory configured to store data output from the buffer block; and
a NAND flash memory controller configured to control the NAND flash memory,
wherein the NAND flash memory comprises a page buffer configured to transmit the data output from the buffer block to a memory cell array and when the ‘m’ unit buffers are all filled with data, data stored in each of the ‘m’ unit buffers is transmitted to the page buffer.

14. The data processing device of claim 12, wherein the compressor includes a compression sensor configured to determine and transmit the size information of the compressed data to the CPU and the device further includes a decompressor configured to decompress the compressed data.

15. A data processing device comprises:
a buffer block including a first buffer of a first size and a second buffer of a second size that is greater than the first size;
a flash memory;
a compressor configured to compress original data input to the device from an external source to generate compressed data and output the compressed data;
a compression sensor configured to measure a size of the compressed data and output the measured size;
a central processing unit CPU receiving the measured sized,
wherein the CPU writes the compressed data into the first buffer when the measured size is the first size or lower, and then writes the compressed data from the first buffer to the flash memory,
wherein the CPU writes the compressed data to the second buffer when the measured size is greater than the first size and less than or equal to the second size, and then writes the compressed data from the second buffer to the flash memory, and
wherein the CPU writes the original data to the flash memory when the measured size is greater than the second size.

16. The data processing device of claim 15, wherein the flash memory includes a page buffer and the data written to the flash memory by the CPU is written to the page buffer.

17. The data processing device of claim 15, wherein the flash memory is a NAND flash memory.

18. The data processing device of claim 15, wherein the second size is twice the first size.

19. The data processing device of claim 15, further comprising a decompressor configured to decompress the data written to the flash memory.

20. The data processing device of 15, further comprising:
a host interface receiving the original data from the external source;
a flash memory controller interfacing the CPU with the flash memory; and
a bus connecting to the host interface, the CPU, the compressor, the buffer block, and the flash memory,
wherein the CPU controls output of the original data from the host interface to the compressor via the bus during a first period,
wherein the CPU controls output of the compressed data from the compressor to the buffer block via the bus or output of the original data from the host interface to the flash memory controller during a second period after the first period, and
wherein the CPU controls output of the compressed data from the buffer block to the flash memory via the bus during a third period after the second period when the compressed data has been output to the buffer block.
